(19) United States
(12) Patent Application Publication
(10) Pub. No.: US 2003/0015694 A1
(43) Pub. Date: Jan. 23, 2003

(54) Fence wire stretcher handle construction

(76) Inventor: David W. Cooper, Adams County, NE (US)

Correspondence Address: BANNER & WITCOFF, LTD., TEN SOUTH WACKER DRIVE, SUITE 3000, CHICAGO, IL, 60606, US

(21) Appl. No.: 09/909,155

(22) Filed: Jul. 19, 2001

(51) Int. Cl. B66F 3/00

(52) U.S. Cl. 254/230

(57) ABSTRACT

A fence wire stretcher includes an ergonomically constructed handle formed from a single flat planar sheet of metal with a generally tubular hand grip end and projecting legs or extensions therefrom for operation of a clamp advance mechanism.

### BACKGROUND OF THE INVENTION

In a principal aspect, the present invention relates to a fence wire stretcher and, more particularly, to a new handle construction for use in combination with a wire fence stretcher.

A wire fence stretcher used to grip and tighten single strands or multiple strands of fence wire typically includes a mechanism to grip the opposite free ends of wire and to draw those ends together so that they may be connected by twisting or with a clamp or connector device. Numerous prior art patents depict and disclose such fence wire stretcher devices, including U.S. Pat. No. 3,825,228 for a Wire Stretcher in the name of Greutman; U.S. Pat. No. 2,937,851 for a Wire Stretcher in the name of Greutman et al.; and more recently U.S. Pat. No. 6,105,937 for a Fence Wire Stretcher Having Strand Holder For Permitting Repeated Operations of Strand Tensioning Carrier in the name of Hay. All of these patents are incorporated herewith by reference, it being noted that applicant has in the past made fence wire stretchers of the type depicted in one or more of the aforesaid patents.

A problem that has been observed with respect to such fence wire stretchers is associated with the design of the handle. Typically, the operating handle for such fence wire stretchers, as depicted in the reference patents, is a flat metal bar with rivets extending through openings in the bar to attach the handle to a mechanism which advances a moveable jaw clamping device designed to grip the wire which is being tightened. Often, a pair of flat stock elements are riveted or welded together to form a handle, again, as depicted in the noted prior art references. The handle is then operated by gripping and reciprocal movement about a pivot connection.

While such handles are operationally satisfactory, they require extra manufacturing operations in order to make and assemble the parts. Moreover, the use of such a handle is generally uncomfortable because the narrow edge or side of the handle tends to “cut” into the hand of the operator of the fence wire stretcher device. Thus, there has developed a need for an improved handle construction for use in combination with a fence wire stretcher.

### SUMMARY OF THE INVENTION

Briefly, the present invention comprises an improved pivotally reciprocating handle construction for use in combination with, and as an improvement to, a fence wire stretching device. The fence wire stretching device is of the type which includes a generally fixed jaw for attachment to or clamping a wire and a moveable jaw for attachment to a second wire and mounted on a notched bar. The handle is fixed to an advance mechanism which effects movement of the moveable jaw in incremental, serial steps so as to move the jaws toward one another as they are separately attached to wires thereby tightening the wires with respect to each other and enabling the wires to be joined together. The handle construction is ergonomically beneficial in that it includes an operating end comprised of a tubular shaped section which is easy to grasp and more comfortable than prior art handle constructions. The sides of the tubular end extend longitudinally in the form of spaced plates with pivot points for attachment of the handle to the mechanism which advances the moveable jaw. Because the handle construction is a unitary construction, it eliminates a subassembly step in the manufacturing operation of the wire stretcher and also facilitates attachment of the handle construction to the final tool in a manner that more easily assures alignment of the component parts, namely, the alignment of the handle with the jaw clamp advance mechanism.

Thus, it is an object of the invention to provide an improved fence wire stretching device.

It is a further object of the invention to provide an improved fence wire stretching device with an ergonomically designed, unitary operating handle having an enlarged gripping end and a simplified construction wherein extensions from the gripping end easily align with and attach to a jaw clamping device mechanism associated with the fence wire stretching device.

Yet another object of the invention is to provide a design for an operating handle incorporated in a fence wire stretcher which is economical, easy to manufacture, easy to assemble, durable and ergonomically beneficial.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of the handle of the invention in combination with a wire stretcher;

FIG. 2 is a bottom plan view of the handle of FIG. 1;

FIG. 3 is a side elevation of the handle of FIG. 1;

FIG. 4 is an attachment end view of the handle of FIG. 1;

FIG. 5 is an end view of the hand grip end of the handle of FIG. 1;

FIG. 6 is a bottom view of the handle of FIG. 1;

FIG. 7 is a plan view of the stock pattern from which the handle is manufactured; and

FIG. 8 is an exploded isometric view of a fence wire stretcher incorporating the handle construction of the invention

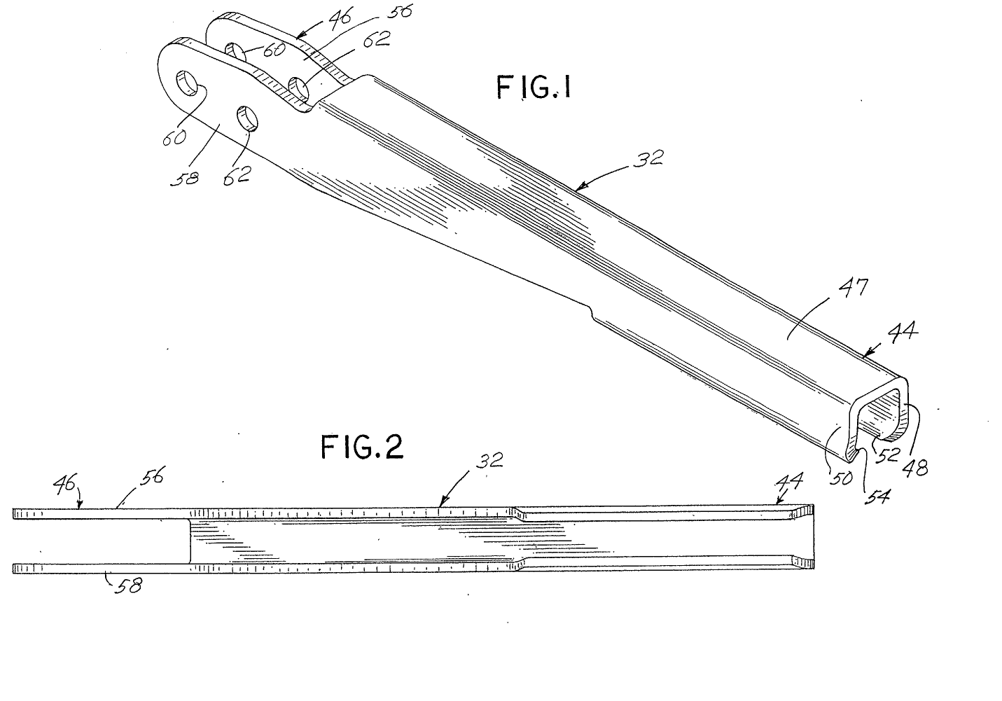

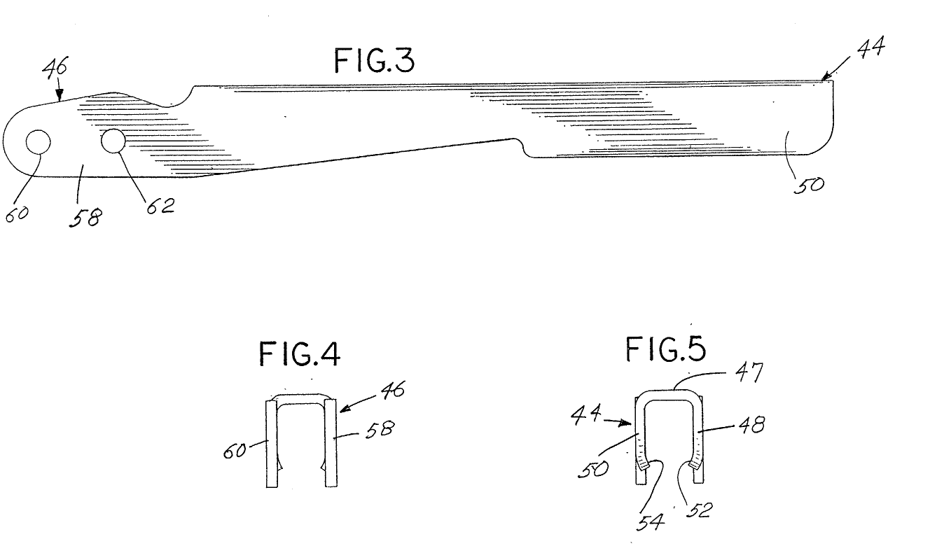

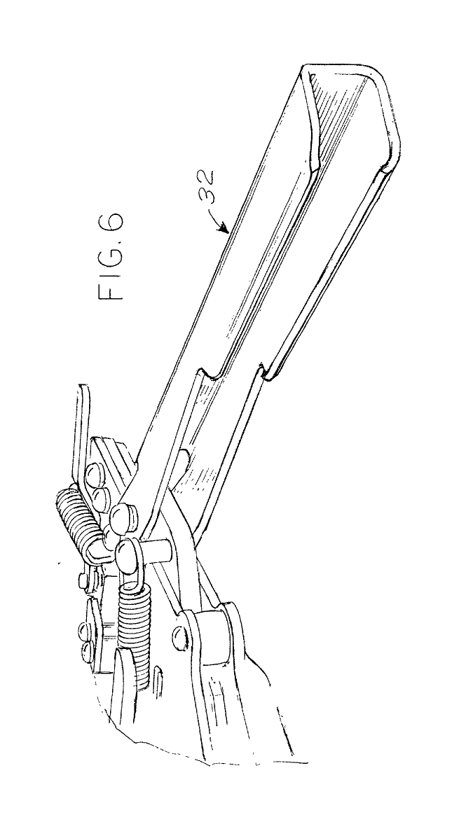

### DESCRIPTION OF THE PREFERRED EMBODIMENT

Referring first to FIG. 8, there is depicted in an exploded view a typical fence wire stretcher construction. Such devices include a longitudinal notched bar 20 with a series of spaced notches 22 along the lower edge thereof A fixed jaw or clamp assembly 24 is attached to one end of the notched bar 20. A moveable jaw or clamp assembly 26 is slidably mounted on the notched bar 20. The moveable clamp assembly 26 includes an advance mechanism 28 including a ratchet pawl 30 that cooperates with notches 22 to advance the movement of the moveable clamp 26 longitudinally and slidably in incremental steps on the bar 20. The ratchet pawl 30 is advanced in response to pivotally reciprocating movement of the handle 32 which is attached to the advance mechanism at two pivot axes 34 and 36, the handle 32 being attached by means of pivot pins or rivets 38 and 40. Reciprocation of the handle 32 back and forth will thus effect movement of the moveable jaw 26 toward the fixed jaw 24 thereby enabling wires held by the respective jaws 24, 26 to be drawn together for coupling.

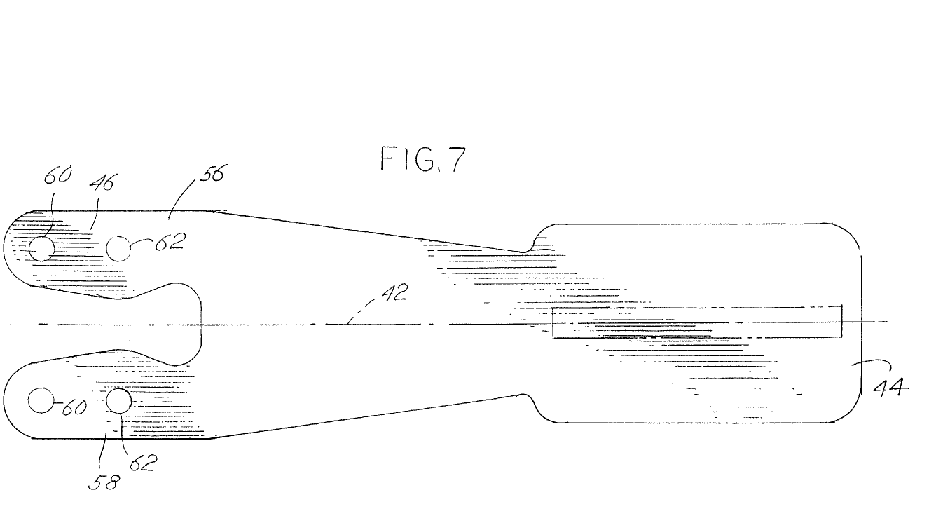

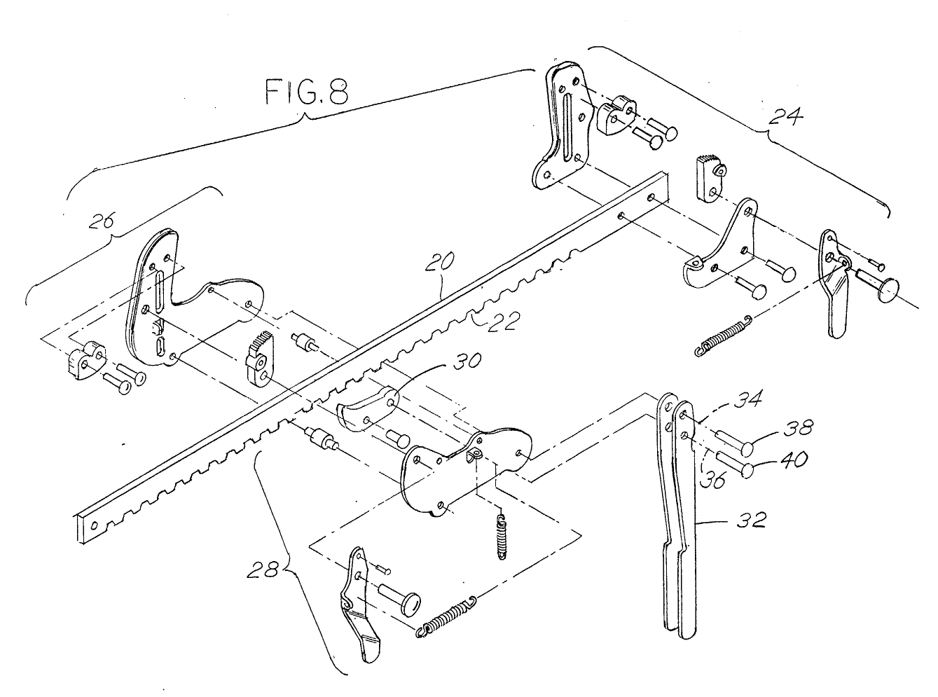

The handle 32 of the invention, which is utilized in combination with fence wire stretchers of the type disclosed, is formed from flat planar metal stock cut in the pattern depicted in FIG. 7. The handle 32 includes a longitudinal center line axis 42. The axis 42 extends from the hand grip end 44 to the clamp mechanism attachment end 47. The flat planar stock is formed in a generally tubular fashion about the axis 42 to form the hand grip end 44. Thus, in cross section, the hand grip end 44 includes a crown section 47 which is arched or arcuate, a first side leg 48 and a spaced parallel, generally flat, planar second side leg 50. The bottom edges of each side leg 48 and 50 subtend to the crown section 47 and extend partially inwardly to form edge extensions 52 and 54 respectively. The entire hand grip end 44 thus has a generally smooth partially circumferential configuration which facilitates utilization of the handle 32 and is ergonomically more sound than prior handle constructions. Additionally, by having a crown section 47 which is in the range of 1-2 inches wide, it is possible to provide better manual contact and thus better mechanical advantage when utilizing the handle 32.

The attachment end 46 of the handle includes a first, flat, planar extension of leg 48, namely, extension 56 and a second flat planar extension 58 parallel to the first. It is to be noted that the spacing of the extensions 56 and 58 is determined by the spacing of the legs 48 and 50 and thus comprise flat planar extensions thereof. Each extension 58 and 56 includes a first pivot point connection 60 and a second pivot point connection 62 which are aligned for appropriate interaction with the pivot pins 38 and 40, respectively. The legs 56 and 58 thus define planar sections but with a space therebetween so that the handle may be effectively reciprocated without interfering with the clamp advance mechanism. The handle 32 will generally have a total length in the range of 10-15 inches. The length of the hand grip portion is typically in the range of 3-6 inches. This facilitates necessary mechanical advantage to be associated with the handle 32, although other dimensional characteristics may be adopted.

The handle 32 is thus a unitary single member formed from a flat planar, metal sheet having a generally tubular configuration but further including separate parallel flat extensions 56 and 58. It is possible to very the configuration of the handle and in particular the configuration of the midsection for purposes of aesthetic desirability. Preferably, the corners of the handle are rounded in order to avoid sharp surfaces. Again, the form and shape thereof will have aesthetic implications. Thus, while there has been set forth the preferred embodiment of the invention, it is to be understood that the invention is limited only by the following claims and equivalents thereof.

What is claimed:

1. In a fence wire stretching device of the type including an elongated bar having a plurality of notches along one edge, a first wire clamp jaw at one end of said bar and a moveable wire clamp jaw, slidably mounted on the bar with a jaw clamp advance mechanism for serially engaging notches in the bar to advance and hold the moveable wire clamp jaw on the bar, and an operating handle for operating the jaw clamp advance mechanism, said handle pivotally attached to the jaw advance clamp mechanism at two spaced pivot points and reciprocal about the two pivot pints to effect advance movement of the jaw clamp toward the first wire clamp jaw, the improvement comprising, in combination, an ergonomic operating handle construction, said operating handle construction comprising a unitary formed member having a longitudinal axis, an attachment end with first and second longitudinally spaced pivot point attachments and an opposite hand grip end, said formed member being formed from a flat planar sheet of metal worked to form a generally tubular configuration at the hand grip end with a generally U-shaped cross section defined by a crown section and first and second, parallel, spaced generally flat planar leg sections projecting from the opposite sides respectively of the crown section, said leg sections only projecting in a straight line axially to define the attachment end comprising first and second, flat, spaced extensions having the first and second pivot point attachments whereby the jaw clamp advance mechanism fits between and through the leg sections, said crown section subtending inwardly turned opposed edges of the leg sections to thereby form a continuous, smooth partially circumferential surface at the hand grip end.
